(19) United States
(12) Patent Application Publication
(10) Pub. No.: US 2012/0068381 A1
(43) Pub. Date: Mar. 22, 2012

(54) MOBILE SELF-CONTAINED STONE-MAKING AND CONCRETE-PROCESSING FACTORY

(75) Inventor: Gary Troke, Perth (CA)

(73) Assignee: INTERNATIONAL STONE PRESS 2008 INC., Perth, ON (CA)

(21) Appl. No.: 13/322,541

(22) PCT Filed: May 28, 2009
(86) PCT No.: PCT/CA2009/000775

§ 371 Date: Nov. 25, 2011

(51) Int. Cl. B28B 3/00; B28B 5/08

(52) U.S. Cl. 264/319; 425/62

(57) ABSTRACT

A novel mobile self-contained stone-making and cement-forming factory comprises, in general, four main components, namely (1) a power plant, (2) a receptacle for receiving local aggregate, (3) a batching module for mixing aggregate with cementitious material and water and for feeding the batch to a compression station and (4) the compression station for compressing the batch into a stone, block, paver, tile, brick or other stone-type product of variable size, colour, and surface finish. These main four components are supported together on a trailer or other portable frame that can be towed or otherwise transported to the construction site. Optional compression plates can be provided to produce customized double-faced stone products. The mobile factory-enables efficient, inexpensive, onsite manufacturing of a broad range of different stone products.

### CROSS-REFERENCE TO RELATED APPLICATIONS

This is the first application filed for the present invention.

### TECHNICAL FIELD

The present invention relates generally to stone-making and concrete-processing factories and, in particular, to mobile stone-making and concrete-processing factories.

### BACKGROUND

Traditionally, building blocks, stones, bricks, pavers, interlock, cladding and the like are constructed at a factory and transported to the construction site for assembly. Due to the substantial weight and bulk of these blocks, stones, bricks, etc., the transport costs are high, thus increasing the overall cost of the building. Where the construction site is remote, and thus far from the factory, the transport costs can become prohibitively high.

Some attempts have been made to develop mobile factories that can be brought to the construction site to minimize construction costs. Some examples are the technologies disclosed in U.S. Pat. No. 4,725,216 (Foster), U.S. Pat. No. 5,785,420 (Schuff), U.S. Pat. No. 4,569,649 (Gross), PCT International Publication WO 2007/115233 (Jennings) and Japanese Patent Application JP 10323812A2 (Ushigome).

With respect to the Foster reference, this prior-art machine does not have a separate receptacle for receiving local aggregate that is distinct from the batching or mixing chamber. The Foster reference describes loading raw materials directly into the mixing chamber.

With respect to the Schuff reference, there is no compression station for forming blocks.

With respect to the Gross reference, this is merely a machine for forming compressed earth blocks, similar to WO 2007/115233 (Jennings), in that there is no batching module for mixing the aggregate with cementitious material and water.

With respect to the Ushigome reference, this machine is only a press machine carried by a trailer. There is no aggregate receptacle and distinct batching module.

Therefore, until the invention of the mobile factory described and claimed in the present application, there did not exist a fully portable and self-contained machine capable of manufacturing blocks and stone products onsite from local aggregate. This invention represents a radically new approach to the onsite making of stone products.

### SUMMARY

In broad terms, the present invention is a novel mobile, self-contained stone-making and cement-forming factory. This mobile factory comprises, in general, four main components, namely (1) a power plant, (2) a receptacle for receiving local aggregate, (3) a batching module for mixing aggregate with cementitious material and water and for feeding the batch to a compression station and (4) the compression station for compressing the batch into a stone, block, or brick.

Unlike all pre-existing machines known to the applicant, this novel mobile factory is entirely self-contained and enables blocks, bricks or stones to be manufactured on site using local aggregate. This new technology revolutionizes building practices since blocks, bricks, stones, and the like can be easily, efficiently and inexpensively manufactured on site, thus entirely obviating the need to transport building blocks, brick and stones to the construction site.

This mobile factory (portable machine) can be used to produce a wide variety of different stones such as, for example, pavers, cladding, interlock, retaining wall stones, building blocks, patio stones, curb and step stones, custom stones and other types of bricks. Optionally, the machine may include a mortar pump that can be used for producing pre-casts and for spray-on application of mortar to work areas.

In main embodiments of the invention, the mobile factory is a trailer-mounted machine that can be towed by a utility vehicle, off-road vehicle, truck, pickup truck, or other vehicle. The machine is entirely self-contained as it has its own power plant or engine for driving a compression system for compression forming of stones, blocks or bricks. Although the main embodiment of the machine, as illustrated in the attached figures, is a trailer-mounted factory, it is to be expressly understood that the machine (mobile factory) could also be mounted directly on a flatbed truck, boat, barge, train car, or any other type of vehicle. In a variant, the power plant of the mobile factory may be shared with the vehicle or a power takeoff (PTO) may be used to drive either the compression station or to provide propulsion for the vehicle.

Accordingly, one main aspect of the present invention is a mobile factory comprising a portable frame for supporting the mobile factory and for enabling the mobile factory to be displaced to a construction site, a receptacle for receiving local aggregate, a batching module for mixing the local aggregate with cementitious material and water to thereby create a batch, a compression station for compressing the batch into a stone product, and a power plant for powering the batching module and the compression station.

In one set of embodiments of this invention, a pair of removable compression plates is inserted into a compression chamber of the compression station to produce customized surface finishes on two sides of the stone product when the stone product is compressed in the compression chamber.

In another set of embodiments of this invention, the batching module comprises a measuring module for receiving aggregate and a mixer disposed beneath the measuring module, the mixer having mixing paddles equipped with wear bars. A mixer-lifting cylinder may be provided for lifting the mixer from a batch-mixing position posture to a batch-dispensing posture. The paddles act to dispense the batch from the mixer when the mixer is in the batch-dispensing posture.

In yet another set of embodiments of this invention, the mobile factory optionally comprises a guillotine for shearing stone products produced by the compression station, the guillotine being connected to a compression cylinder of the compression station.

The mobile factory may also optionally include a PSI testing adapter, the PSI testing adapter being driven by a compression cylinder of the compression station. This PSI testing adapter may be connected to the guillotine.

A further main aspect of the present invention is a method of onsite manufacturing of stone products and processing of cement. The method entails transporting a mobile self-contained stone-making and cement-processing factory to a construction site, powering the mobile factory using an onboard power plant, loading local aggregate into a receptacle of the mobile factory, batching the local aggregate with water and cementitious material, compressing the batch in a compression chamber to produce a stone product, and extracting the stone product from the compression chamber.

A related aspect of this novel technology is an innovative method of producing stone products with patterned faces on two opposing sides. This novel method entails inserting a first patterned compression plate into a compression chamber, inserting a second patterned compression plate into the compression chamber, dispensing a batch from a mixer into the compression chamber, compressing the batch in the compression chamber to form a stone product, and separating the first and second patterned compression plates from the stone product after a predetermined period of time has elapsed to reveal patterned faces on the stone product. The patterned compression plates can be identical or different. This technology enables efficient onsite production of stone products with one or two customized faces bearing any desired designs, letters, symbols, logos, etc. As a corollary advantage of using these compression plates, the moisture content can be increased beyond what would normally be employed to produce much finer detail and smoother surface finishes. These effects can be achieved without operating at very high compaction pressures, thus prolonging the service life of the machine.

Other aspects, features and advantages of this novel technology will become apparent with reference to the following description and drawings.

### BRIEF DESCRIPTION OF THE DRAWINGS

Further features and advantages of the present invention will become apparent from the following detailed description, taken in combination with the appended drawings, in which:

FIG. 1 is a left-side elevation view of the mobile factory in accordance with one embodiment of the present invention;

FIG. 2 is a right-side elevation view of the mobile factory introduced in FIG. 1;

FIG. 3 is a frontal perspective view of the mobile factory, showing the compression chamber with the door locked down, as well as the product removal tray;

FIG. 4 is a rear perspective view of the mobile factory, showing the tumbler and the hopper lifting cylinders;

FIG. 5 is a rear perspective view of the mobile factory, showing the upper hopper tipped to extract oversized materials;

FIG. 6 is a right-side elevation view of the mobile factory, showing the mixer lifted by the hydraulic cylinders into the material-dispensing mode;

FIG. 7A depicts the first step in a typical loading sequence in which the mobile factory is positioned for loading;

FIG. 7B depicts the second step in the loading sequence in which local aggregate is dumped into the hopper from a tractor bucket;

FIG. 7C depicts the third step in the loading sequence in which excessively large material is ejected after screening;

FIG. 7D depicts the fourth step in the loading sequence in which the hopper measure module is filled;

FIG. 7E depicts the fifth step in the loading sequence in which the batcher bottom is opened to empty the material into the mixer;

FIG. 7F depicts the sixth step of mixing the batch using a hydraulically reversible four-paddle mixer;

FIG. 7G depicts the seventh step of dispensing mixed material onto the material-holding slide and into the compression chamber;

FIG. 8A depicts the compression chamber in a first mode in which it is ready to receive material for compacting into product;

FIG. 8B depicts the compression chamber in a second mode in which the guillotine is affixed;

FIG. 8C depicts the compression chamber in a third mode in which the PSI testing adapter is bolted to the guillotine;

FIG. 9 depicts the threaded pins for scribing product during manufacture or for prepping the block for subsequent shearing;

FIG. 10A depicts the block extractor and material levelling device with the twin-handle extractor retracted;

FIG. 10B depicts the block extractor and material levelling device with the twin-handle extractor extended;

FIG. 10C depicts the block extractor and material levelling device with the twin-handle extractor retracted during a compression cycle; and

FIG. 11 depicts three different types of reusable injection-molded plates that enables the manufacture of a wide variety of double-faced stone products.

It will be noted that throughout the appended drawings, like features are identified by like reference numerals. It should furthermore be noted that the drawings are not necessarily to scale.

### DETAILED DESCRIPTION

In general, and by way of overview, the present invention provides a mobile, self-contained factory for not only making stones, blocks, compressed earth blocks, pavers, tiles, and other such stone products but also for processing cement. In its broadest conception, the novel mobile factory comprises four main components mounted on a trailer or other such mobile or portable frame, namely (1) a power plant or engine, (2) a receptacle for receiving local aggregate, (3) a batching module for mixing aggregate with cementitious material and water, and (4) a compression station for receiving the batch and for compressing the batch into a stone, block, brick, paver, interlock, tile, or other such product. This novel machine enables a new method of manufacturing stone products. As will be elaborated below, this innovative technology revolutionizes the construction industry by enabling builders to manufacture stone products onsite using local aggregate, thus dramatically reducing construction costs.

Main illustrative embodiments of this invention are now described below having regard to the appended figures. Described below are the novel mobile factory, the novel methods and the various products that can be made using this mobile factory and the related methods.

Mobile Factory

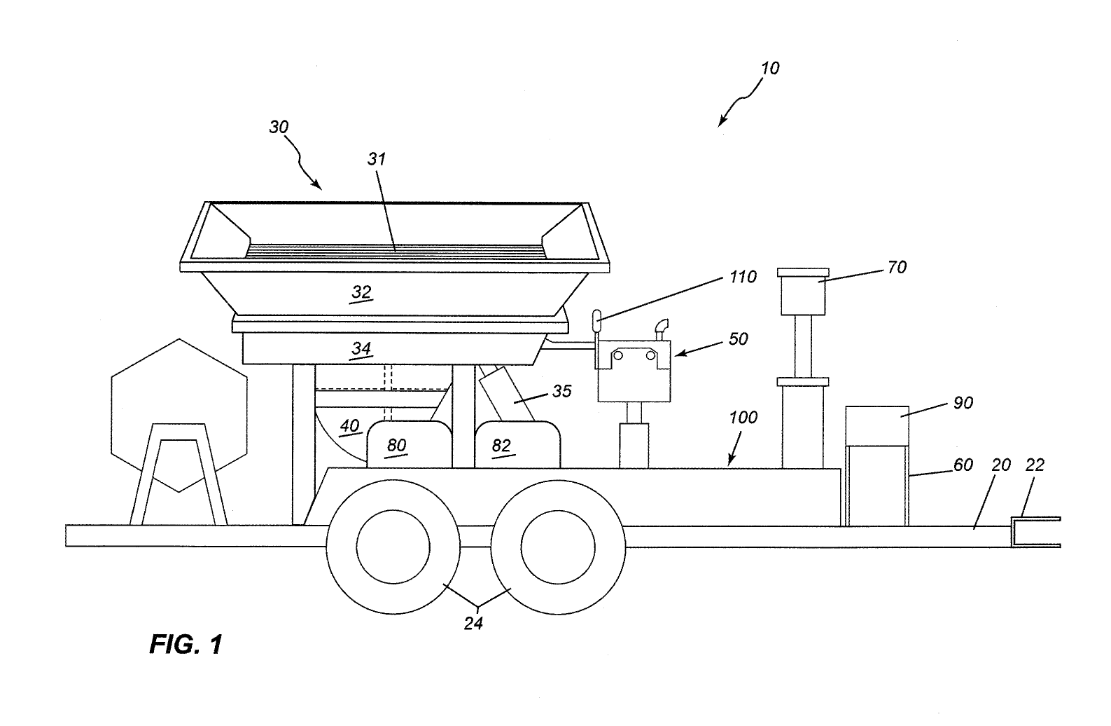

FIG. 1 is a left-side elevation view of the mobile factory in accordance with one embodiment of the present invention. This figure depicts a mobile factory generally designated by reference numeral 10 comprising a portable frame (e.g. a trailer or equivalent) for supporting the mobile factory and for enabling the mobile factory to be displaced (e.g. towed) to a construction site. The mobile factory also comprises a receptacle 30 (e.g. a movable hopper with aggregate screening) for receiving local aggregate. The mobile factory also includes a batching module 40 (e.g. that includes a measuring module and mixer) for mixing the local aggregate with cementitious material and water to thereby create a batch. The mobile factory further includes a compression station 50 (e.g. with hydraulically operable compression cylinder) for compressing the batch into a stone product. A power plant 60 (e.g. a diesel engine) is provided on the mobile frame for powering the batching module and the compression station. Thus constituted, this novel mobile factory is an entirely self-contained and self-sufficient stone-making machine. In addition, the mobile factory has a number of additional innovative features (e.g. custom-patterned compression plates and mortar pump, to name but two of the principal ones) that will also be introduced below. These additional features facilitate the task of manufacturing stone products and processing cement.

FIG. 1 shows a trailer-mounted mobile factory. The trailer may be a standard roadworthy trailer having a trailer hitch coupling 22 in the front, a plurality of wheels 24 with tires, brake-lights in the back, reflectors, etc. The particular version of the mobile factory illustrated in this application can easily be towed by a small utility vehicle or a pickup truck, for example. Simple vertically extending feet may be lowered from the frame to the ground and secured (e.g. with locking pins) to stabilize the machine during operation. Alternatively, screw-operated or hydraulic stabilizers can be provided on the trailer to stabilize the machine during operation.

FIG. 1 shows that the power plant 60 of the mobile factory, in this particular case, is a removable diesel engine that can be removed from the frame and operated at a distance from the frame in order to reduce noise and vibration for the operator. This can be accomplished easily by quick-coupled hydraulic hoses to any desired length up to 50 ft (approximately 15.5 metres), beyond which pressure losses in the hydraulic lines begin to discernibly degrade hydraulic power. The diesel engine can be controlled by a control console shown in FIG. 1. A diesel fuel tank may be provided on the trailer to supply fuel to the diesel engine via a suitable fuel line. Other types of engines can be substituted.

FIG. 1 shows how a top portion of a hopper or “hopper top” (i.e. that is part of the receptacle 30 introduced above) can be easily loaded with local aggregate using a mechanical backhoe, front-end loader, tractor or even by manual labour (i.e. a person shovelling in the aggregate). As is well known in the art, the aggregate may include rock, crushed stone, gravel, sand, slag, etc., or combinations thereof.

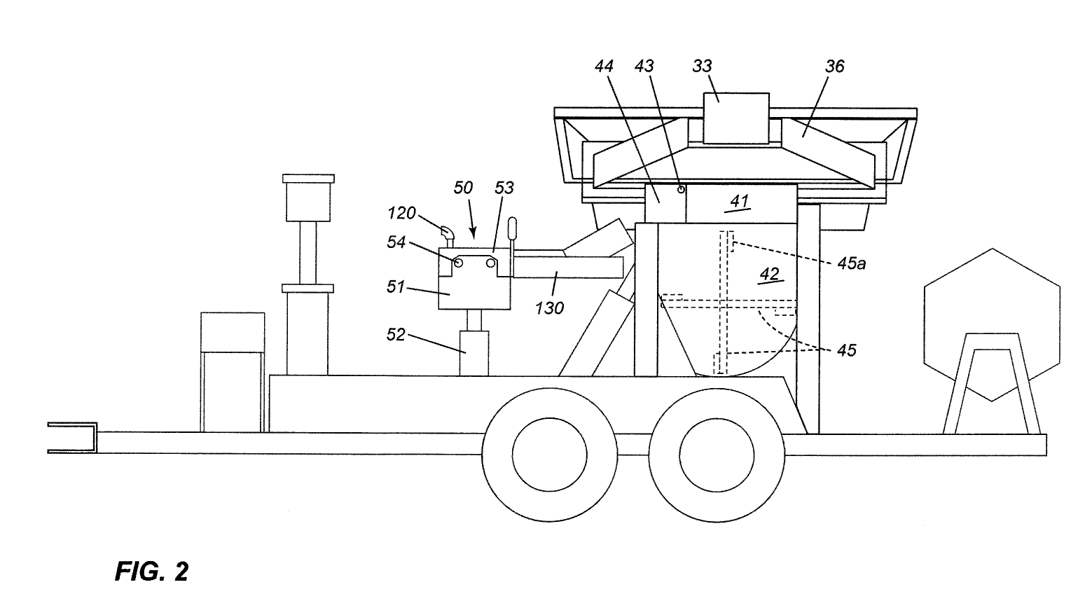

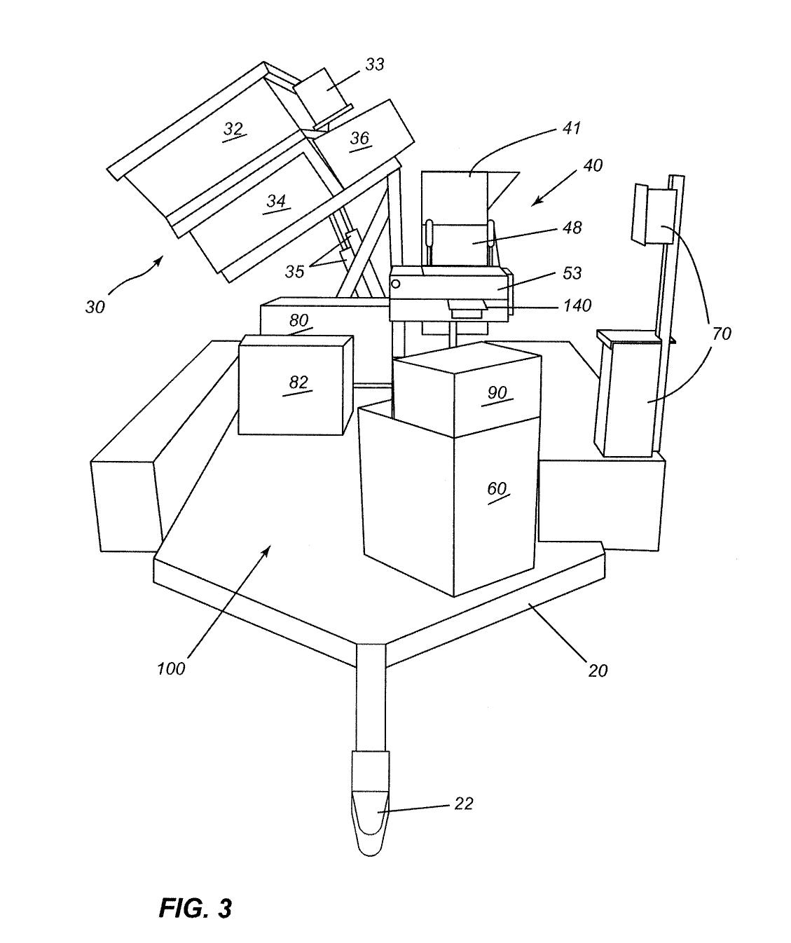

As depicted in FIG. 1, a vibrating aggregate screen 31 (having a variably sized mesh) disposed inside the movable hopper top 32 can be used to separate larger unwanted particles or “chunks” of aggregate from the useable aggregate. This vibrating aggregate screen can be vibrated using an attached vibrator 33 (shown in FIGS. 2 and 3) that, in turn, can be operated via remote control from the tractor operator's station. The sifted aggregate will fall by gravity into the hopper bottom aggregate storage compartment 34 for storage and later use (i.e. into the bottom portion of the receptacle). The top portion of the hopper can be tilted (pivoted) by way of a hydraulic cylinder 35 (or equivalent) to eject (i.e. dump) the unwanted larger chunks of aggregate back onto the ground. The hydraulic cylinder that tilts the movable hopper top can be controlled from the control console 70 shown in FIG. 1. Accordingly, this novel machine allows local aggregate to be used in the production of stone products, thus saving the cost of handling and transport.

FIG. 1 also shows the water tank 80 for the storage of wash-down and clean-up water, which is connected to a water pressure pump (not shown) and a nozzled hose (also not shown) which is accessible near the control console. Also, this water tank stores the water (moisture) needed for the aggregate and cement (or cementitious material). A water and add mixture tank 82 may also be provided. An add mixture to help repel water and assist in compaction may also be added, as required by the operator in order to produce different types of stone product. Other chemical admixtures may also be added as required and carried with the mobile factory (e.g. accelerators, retarders, plasticizers, pigments, air entrainments, bonding agents, etc.). This figure also shows the hydraulic fluid storage 90 coupled to, or otherwise disposed above, the diesel engine.

All machinery and accessories, with the exception of the hopper screening device, tumbler and mortar pump, which can be operated by remote control as well, are controlled from the central control console 70 depicted in FIG. 1. This control console is ergonomically disposed immediately beside the operator platform 100. During stone production operations, the operator typically stands on the operator platform so as to be within easy reach of the control console and also the block-extractor handles 110. A sunshade or parasol (not shown) can be provided on a stand mounted to the portable frame to provide shade for the operator. This sunshade may be foldable for when the trailer is being towed. All hydraulics are controlled electronically with the exception of the mixer-lifting hydraulic cylinder and the mixer paddles. The latter are stick-controlled because better control can be achieved by manipulating stick-controlled hydraulic valves. The mixer height can be adjusted more precisely and the amount of batch material extracted into the compression chamber via the mixing paddles can be regulated and controlled more accurately with stick-controlled hydraulic valves. Also, the amount of moisture injection into the aggregate can be controlled by a timer from this station (control console). For safety reasons, the operator is required to hold the button (switch) that lowers the compression chamber lid, locks the lid and initializes the block forming. Requiring the operator to hold this button (switch) down prevents fingers and limbs from being injured. In a variant, two buttons (switches) are provided, thus requiring both hands to be fully occupied when the lid is closed and locked and the block compacted. It should be noted that this compression chamber lid is a hydraulically operated lid that has an inline throttle to control the speed of both upward movement and downward movement, i.e. both the opening and closing actions of the lid.

FIG. 2 is a right-side elevation view of the mobile factory introduced in FIG. 1. FIG. 2 shows the aggregate dispensing chute 36. When raised, this chute funnels the aggregate stored in the bottom of the hopper into the measuring module 41 (that forms part of the batching module 40). On top of this chute 36 is the hydraulic removable remote-controlled vibrating device (vibrator 33), which can vibrate the chute to assist gravity with the sliding down the chute of the stored aggregate. In other words, the vibrator 33 is not only useful for vibrating the vibrating aggregate screen (as described earlier) for sifting the loaded aggregate but is also useful in shaking the chute 36 to help the aggregate fall into the measuring module 41. The sliding aggregate material fills the measuring module 41 on top of the mixer 42. It is then possible to add a desired percentage of pre-packaged cement and optional colorant. This allows accurate, repetitious batching to ensure desired strength and color consistency. Directly in front of the measuring module is the moisture injection nozzle 43. This nozzle 43 sprays the aggregate with water and add mixture if desired, while the various constituents in the mixer 42 are being agitated. This nozzle 43 is located in the material outlet opening 44. The mixer 42 has four arms 45 and paddles which are rotated by an extremely powerful hydraulic motor. On the end of the paddles are wear plates 45a (also known as wear pads or wear bars), which can be adjusted to keep close tolerance with the contour of the interior of the mixer. Such an arrangement ensures rapid yet thorough mixing. Once mixed, the batch is transferred to the compression station 50, i.e. into a compression chamber 51 for compaction of the batch into a block or stone product using a hydraulically powered compression cylinder 52.

As also shown in FIG. 2, the compression station 50 has a compression chamber lid 53 (i.e. a compression chamber cover) that includes locking pins 54 that hydraulically lock the compression chamber lid in place, allowing it to withstand the extreme pressure required to form the product.

As further depicted in FIG. 2, the mobile factory may also be configured to act as a mortar pump for delivering mortar. The compression station includes a mortar pump hose connection 120 to which a mortar-delivery hose (not shown) can be connected. The mortar pump hose connection 120 is situated in this particular version of the machine at the top of the compression chamber. To deliver mortar, a mortar slurry is mixed in the mixer 42. When the mixer 42 is elevated, the mortar slurry travels down the material holding slide 130 and into the compression chamber. The movable bottom of the compression chamber 51 has been sealed with a travelling gasket plate (not shown). As well, the top lid has a sealing gasket (also not shown). When the compression chamber is filled with mortar slurry, the lid is closed, sealed and locked. When the compression cylinder is activated upwards, the only outlet for the mortar slurry is through the mortar pump hose connection 120 and into the mortar hose (not shown). This outlet can be connected to a hose for delivering mortar for many different functions and applications, such as, for example, to fill in and strengthen brick and stone walls or other structures. This is particularly useful for awkward, hard-to-reach places, e.g. back yards, where large conventional equipment cannot pass. The mortar pump can also be used for spraying of stucco. The mortar can also be used for the injection of molds for the forming of mortar-based products, e.g. roof tiles. For this application, special plastic molds are carried with the mobile factory to enable the roof tiles or other mortar-based products to be produced onsite.

FIG. 3 is a frontal perspective view of the mobile factory, showing the compression chamber with the lid/door 53 locked down, as well as the product removal tray 140. The finished product is slid out onto this product removal tray 140 for removal. FIG. 3 also shows the aggregate screening compartment (hopper top) 32 with attached vibrator 33, the aggregate storage compartment (hopper bottom) 34 and its adjacent aggregate dispensing chute 36. The lifting cylinders 35 tilt these hoppers 32, 34 from the posture illustrated in FIG. 3 to a posture in which the dispensing chute 36 is above the batching module 40 whereupon the aggregate is dispensed through the chute 36 into the batching module 40 (in particular into the measuring module 41). The outlet of the measuring module 41 is then opened to deliver a measured amount of aggregate into the mixer 42 below. The mixer 42 used its hydraulically driven paddles to mix the batch with water and cementitious material. It should be noted that cementitious material is not used for a compressed earth block. Thereafter, the batch is delivered via the material slide 48 to the compression chamber. The compressed block is then extracted and disposed on the product removal tray 140 (the small platform that extends outwardly from the compression station). Also visible in this figure are the wash-down water tank 80, water and add mixture tank 82, hydraulic fluid storage 90, removable engine pack 60, trailer hitch coupler 22 and control console 70.

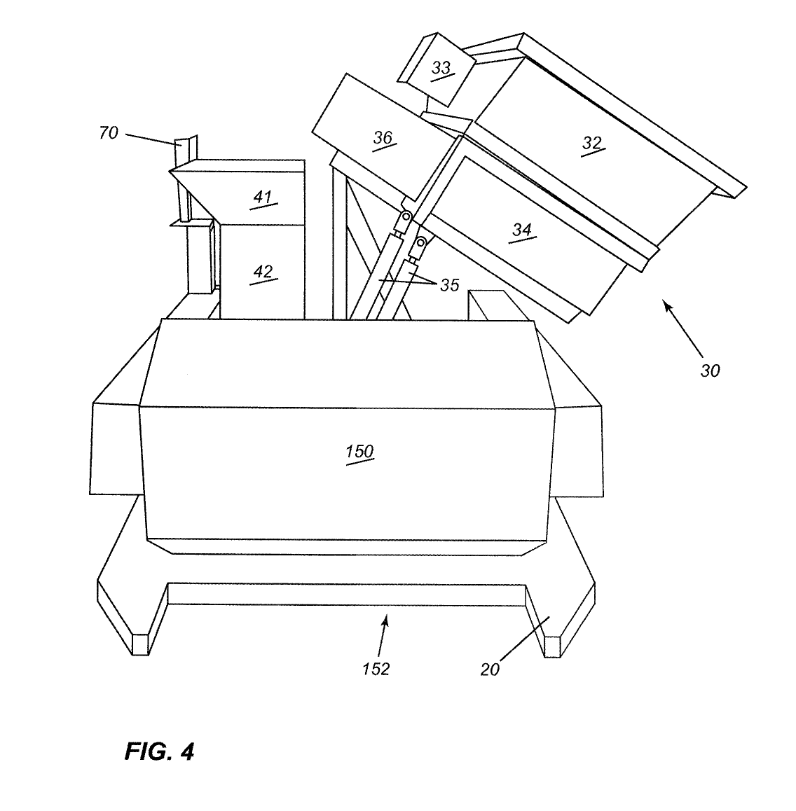

FIG. 4 is a rear perspective view of the mobile factory, showing a tumbler 150 and the hopper-lifting cylinders 35. The tumbler 150 shown on the back is a rotating drum into which the product is placed for tumbling. This tumbling creates different product effects and looks, such as rounded or smooth edges and an old-stone appearance. As shown in FIG. 4, the machine includes an aggregate screening compartment 32, an aggregate storage compartment 34, a vibrator 33, an aggregate dispensing chute 36, a measuring module 41, a mixer 42 and a control console 70. For the purposes of this specification, the term “receptacle” (which is generally designated by reference numeral 30) is meant to include both the top and the bottom hoppers (i.e. both the aggregate screening compartment 32 and the aggregate storage compartment 34 as well as the aggregate dispensing chute 36). For the purposes of this specification, the expression “batching module” (which is generally designated by reference numeral 40) is meant to include both the mixer 42 and the measuring module 41.

FIG. 4 also shows how the frame 20 of the mobile factory may have a bay-shaped opening 152 at one end to provide a space through which tumbled product is allowed to fall directly from the tumbler 150 onto the ground, onto a waiting pallet, into a waiting wheelbarrow or the like.

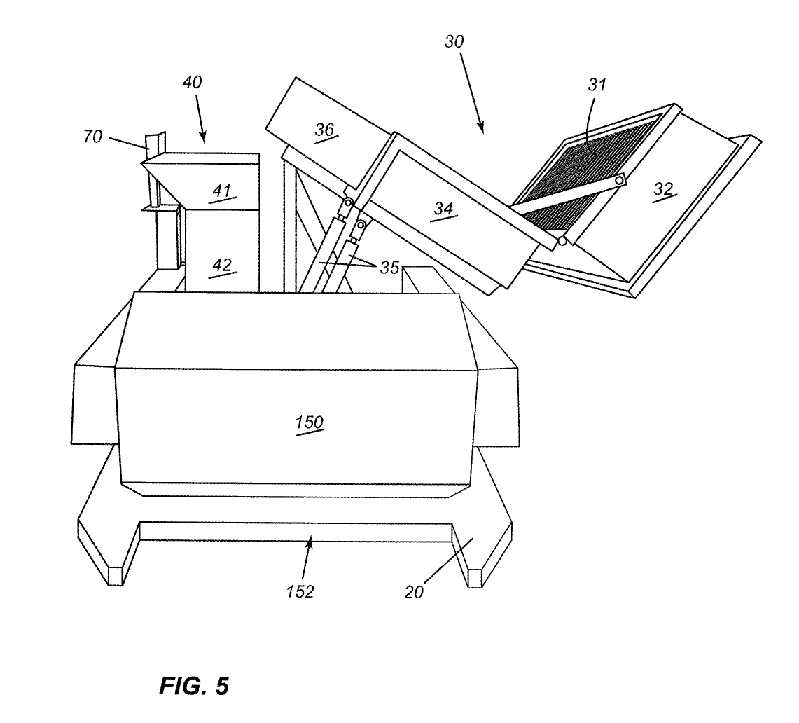

FIG. 5 is a rear perspective view of the mobile factory, showing the upper hopper (aggregate screening compartment) 32 tipped to extract oversized materials. In other words, as described earlier, this depicts how oversized (and thus unwanted) aggregate is dumped out of the aggregate screening compartment 32 by pivoting the top portion relative to the bottom portion (i.e. relative to the aggregate storage 34). This tilting is accomplished by the hopper lifting cylinders 35 controlled by the control console 70. Retained aggregate in the storage compartment 34 is then dispensed via the aggregate dispensing chute 36 into the measuring module when the receptacle is tilted back to its main loading/dispensing position. The measuring module 41 has an outlet for delivering the aggregate into the mixer 42 below. The underside of the vibrating aggregate screen 31 is clearly visible in this figure. This screen 31 defines the bottom of the aggregate screening compartment 32. As an optional feature, the screen 31 can have a variable mesh or can be replaced with another screen having a different mesh size.

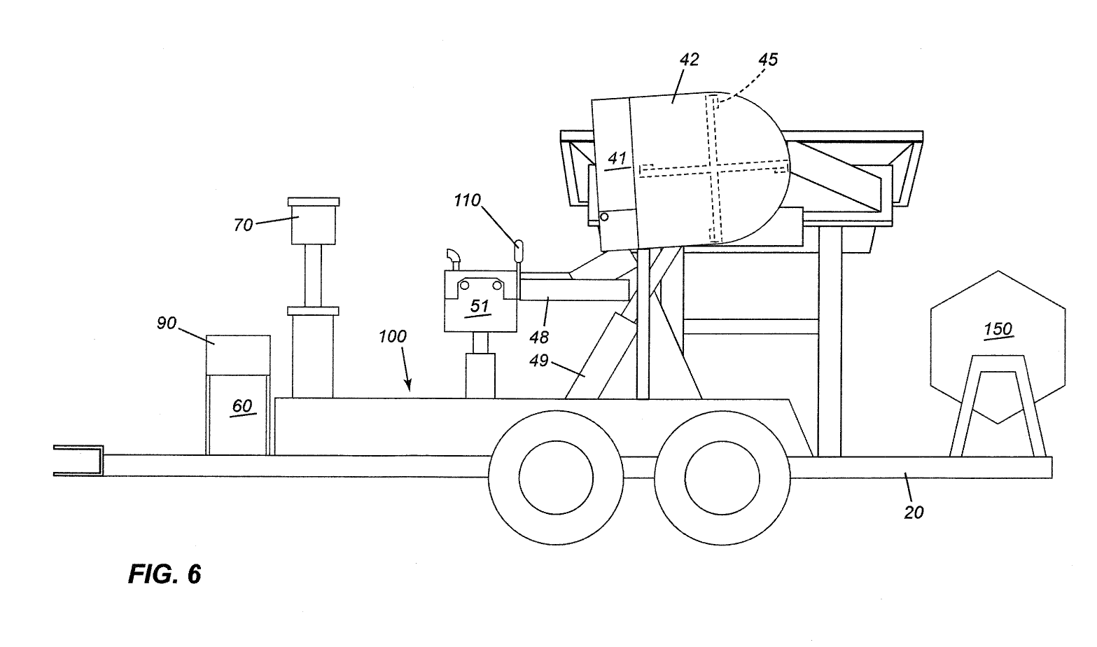

FIG. 6 is a right-side elevation view of the mobile factory, showing the mixer 42 lifted by one or more hydraulic cylinders 49 into the material-dispensing mode. In this position, the mixing paddles 45 can be rotated by the hydraulic motor (not shown but which is a component well known in the art) and controlled by the stick-controlled hydraulic valve (not shown but which is also a component well known in the art) to push a desired amount of material (batch) out and onto the material slide 48 (which may also comprise a holding chute). The block-extractor slide 110 should be in the out (fully extended) position to fill the compression chamber 51 with batch material.

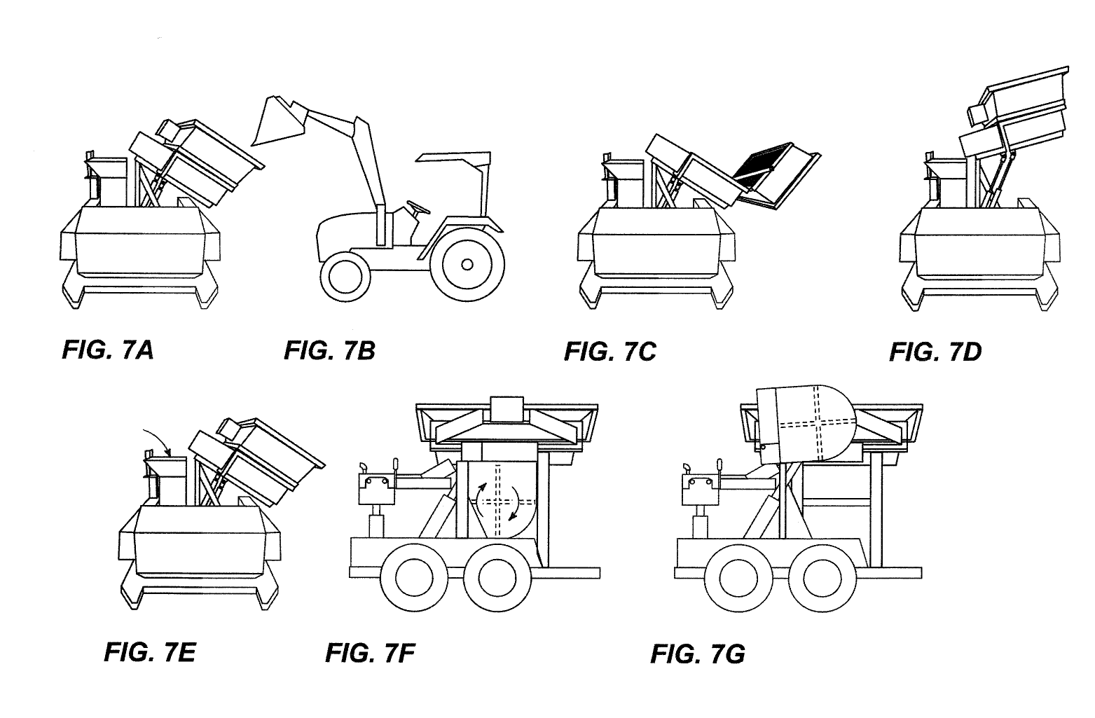

FIG. 7A-7G depicts the process of loading aggregate, making a batch and then loading the batch into the compression chamber in accordance with one embodiment of the novel method. FIG. 7A depicts the first step in a typical loading sequence in which the mobile factory is positioned for loading. FIG. 7B depicts the second step in the loading sequence in which local aggregate is dumped into the hopper from a tractor bucket. FIG. 7C depicts the third step in the loading sequence in which excessively large material is ejected after screening. FIG. 7D depicts the fourth step in the loading sequence in which the measuring module is filled by dispensing aggregate through the aggregate dispensing chute. FIG. 7E depicts the fifth step in the loading sequence in which the batcher bottom (measuring module) is opened to empty the material into the mixer. FIG. 7F depicts the sixth step of mixing a batch using a hydraulically reversible four-paddle mixer. FIG. 7G depicts the seventh step of dispensing mixed material (the batch) onto the material-holding slide and into the compression chamber.

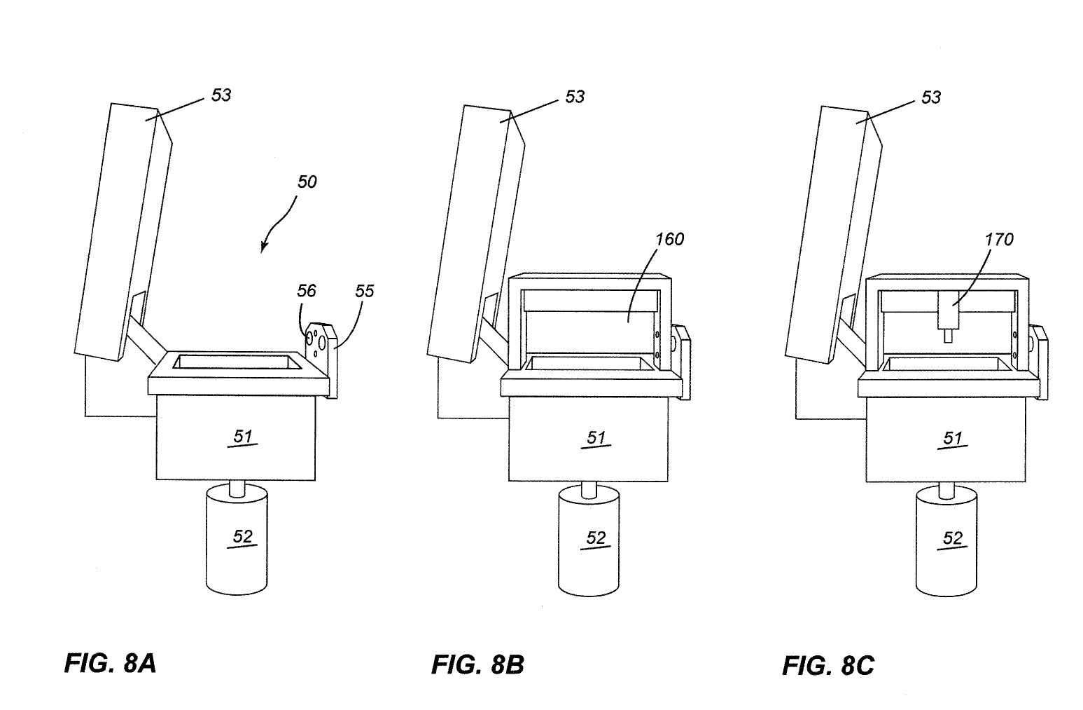

FIG. 8A depicts the compression chamber 51 in a first mode in which it is ready to receive material for compacting into product. In this figure, the compression chamber lid 53 (locking top) is shown locked in the opened position. First, a patterned forming plate (also known herein as a patterned compression plate) is inserted face up. Utilizing a spatula, material (some the prepared batch) is loaded onto the top of this plate for compacting. The plate may be vibrated while the material is loaded to assist with composition. A levelling bar is then passed over the top of the material grading it flat and removing any excess material back to the material holding area. The operator pushes and holds an electrical switch which hydraulically closes the lid 53 and locks the locking pins. This switch is held until a light comes on, indicating full compaction by way of a preset PSI. Another switch is pushed, the lid (door) is unlocked and raised, the block is automatically lifted to the extraction level and stops. The operator then pulls the block-extraction handles of the block extractor 110, the block and forming plates are extracted and the process can then be repeated to produce a new block (i.e. another stone product). It is to be noted also that in the embodiment depicted by way of example in FIG. 8A that the compression station 50 includes a robust locking bracket 55 having holes 56 for receiving the locking pins.

FIG. 8B depicts the compression chamber in a second mode in which a guillotine 160 is affixed. This is a U-shaped steel device with a blade made of hardened steel (or equivalent) that is bolted or otherwise mounted to the compression cylinder. When the cylinder comes up, the block is sheared.

FIG. 8C depicts the compression chamber in a third mode in which a PSI testing adapter 170 is bolted or otherwise mounted to the guillotine. In one specific embodiment, this PSI testing adapter is a vertical bar made of hardened steel (or equivalent) having a cross-sectional profile of exactly one square inch. The bar is configured to protrude into the compression chamber. The product to be tested is placed in the compression chamber and then pressed vertically upwardly by the cylinder against the one-square-inch steel bar until it shatters. A holding pressure gauge on the control console records the highest pressure achieved by calculating this pressure against the force of the cylinder, thereby determining the breaking strength of the product.

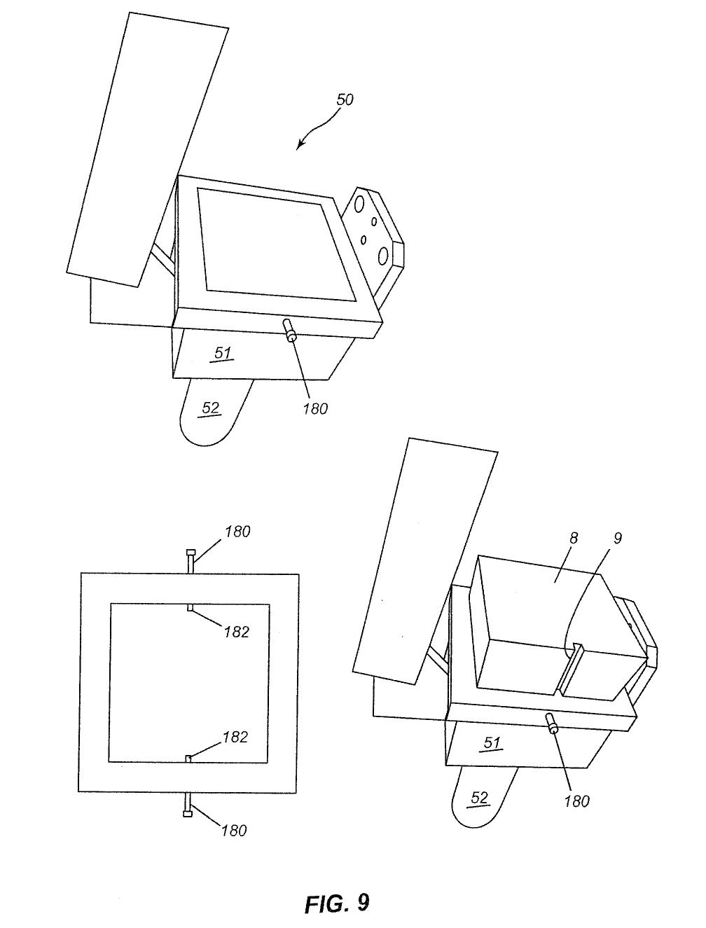

FIG. 9 depicts threaded scribing pins 180 for scribing stone products during manufacture or for prepping the block 8 for subsequent shearing. The scribing pins 180 are pointed inwardly so that an inwardly facing tip 182 of each such pin scribes (or scores) the block 8 as the block is pressed out of the compression chamber 51, leaving a scribe line 9 (groove) along each lateral surface. When subsequently the block 8 is sheared, the shearing of the block 8 will thus follow the scribe line 9 that has been formed by the scribing pins 180. The scribing pins 180 may be made of hardened steel or equivalent material. The scribing pins 180 are threadedly engaged within respective threaded holes in the compression station 50.

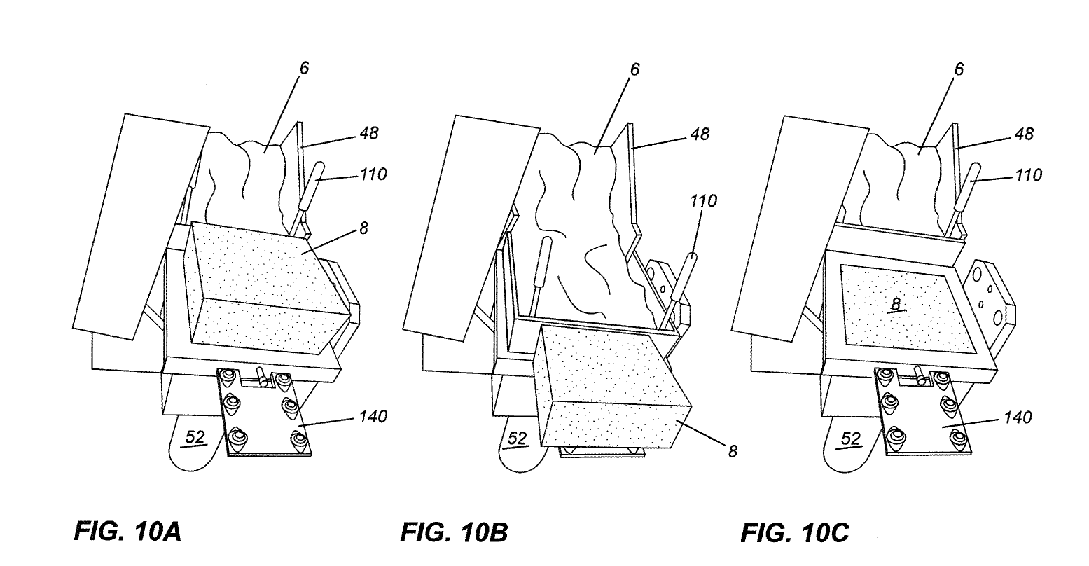

FIGS. 10A-10C illustrate operation of the block extractor and material-levelling device. FIG. 10A depicts the block extractor and material-levelling device with the twin-handle extractor 110 retracted. FIG. 10B depicts the block extractor and material-levelling device with the twin-handle extractor 110 extended. FIG. 10C depicts the block extractor and material-levelling device with the twin-handle extractor 110 retracted during a compression cycle. In operation, the two handles of the block extractor 110 are extended (pulled out) and the block extractor hits the forming plate and pushes it onto the holding platform (product removal tray 140). This activates a proximity switch (not shown but which is a component well known in the art) to return the compression cylinder 52 to its pre-set position. This pre-set cylinder position is readily adjustable by a quick-change limit switch, which determines the thickness of the block. Adjustment or replacement of the limit switch enables the machine to vary the thickness of the blocks being produced. Batch material 6 for the next block is pulled in by a spatula and the device will level and return any excess material to the material-holding area of the material slide and holding chute 48.

This novel technique therefore enables high-quality blocks and stone products to be manufactured onsite inexpensively, efficiently and rapidly.

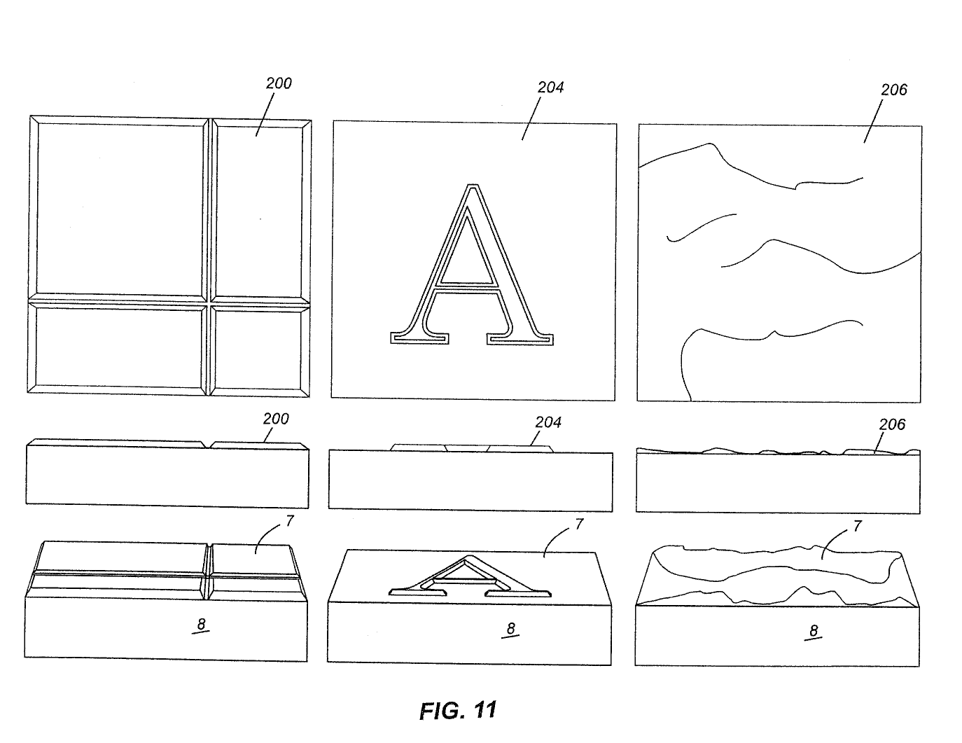

FIG. 11 depicts three different types of reusable injection-molded forming plates 200, 202, 204 that enables the manufacture of a wide variety of double-faced stone products. These forming plates (which are also known herein as compression plates or compaction plates) may be, for example, reusable PVC injection-molded plates although other suitable materials may also be substituted. These forming plates may also be made by techniques other than injection-molding. To produce a block 8 with a patterned face 7, an appropriately patterned compression plate 200, 202, 204 is dropped into the compression chamber. This forming plate is extracted with the compacted block 8 and remains with the block until set. This could be as little as a half hour or up to as many as 12 hours, depending on prevailing climatic conditions. There are many advantages to this novel method of forming blocks and stone products, including a superior-looking, stronger and less expensive stone product. The forming plates are inexpensive to manufacture. In fact, these forming plates may even be manufactured from recycled material. Approximately four to five hundred such plates could be easily transported with each mobile factory. By compressing the blocks using these removable compression plates, each block can have a different pattern, design, logo, letter of the alphabet, number, or image (e.g. wildlife, scenery, etc.) For example, as illustrated in FIG. 11, forming plate 200 has two orthogonally intersecting lines. Forming plate 202, also by way of example only, has the letter A engraved in its top face. Again by way of example only, forming plate 204 has a roughened surface finish to provide a natural, rough-hewn look to the resulting block. These three examples are merely provided to illustrate different ways in which block faces may be designed using this novel technology.

Another corollary advantage of this two-plate compression technique is that material moisture can be increased to give a smoother appearance, stronger bonding and finer imprint detail, all with less compaction pressure, thus extending the service life of the mobile factory.

In a variant, one of the two compression plates can have no pattern or design (simply smooth and flat) in which case a pattern is produced on only one of the two sides of the stone product. This capability to manufacture a double-faced stone was previously not possible using prior-art technologies known to Applicant.

Method

This novel stone-making machine enables a novel method of making stone products. This novel method of onsite manufacturing of stone products and processing of cement therefore entails transporting a mobile self-contained stone-making and cement-processing factory to a construction site (e.g. via trailer, boat, barge, truck, etc.). Once at the site, the method then entails powering the mobile factory using an onboard power plant, e.g. a diesel engine, which can optionally be removed to a remote location to diminish noise and vibration for the operator. A subsequent step then involves loading local aggregate into a receptacle of the mobile factory, e.g. using a front-end loader. Once the local aggregate is loaded and sifted, the next general step entails batching the local aggregate with water and cementitious material to form a batch, and then compressing the batch in a compression chamber to produce a stone product. Finally, the stone product is extracted from the compression chamber. Optionally, the stone products produced by this novel method may be tumbled in a tumbler in order to give the stones a worn appearance and/or to remove sharp edges. In main embodiments of this novel method, the compaction of the block is performed using forming plates (patterned compression plates) which can be used to produce patterns, designs, logos, letters, numbers, symbols, images, etc. on the outer (upper and lower) faces of the block during compaction. The removable patterned compression plates remain affixed to the stone product when it emerges from the compression chamber and these plates are typically only removed from the block after a predetermined period of time has elapsed ranging from 30 minutes to 12 hours, depending on the nature of the batch and the local climate conditions.

In most embodiments of this novel method, screening of the local aggregate is performed prior to batching to ensure that only aggregate of a size particle size is utilized. The screening process may involve vibrating an aggregate screen, storing excess aggregate that has passed through the screen in a hopper bottom aggregate storage, and pivoting the aggregate screen to dump out large pieces of aggregate that have not passed through the aggregate screen. Accordingly, screening of aggregate and rejection of unwanted aggregate is important to ensure that only properly sized aggregate particles are utilized.

Batching may optionally involve adding colorant and add mixtures to achieve the desired results. Accordingly, this method enables a wide variety of differently coloured stone products to be made. The coloured stone products can easily and quickly be made onsite to match existing stones or existing structures, thus providing unparalleled versatility for the operator/constructor.

Optionally, the method further comprises mixing a mortar slurry in a mixer, pouring the mortar slurry into the compression chamber, and actuating the compression cylinder of the compression chamber to thereby force the mortar slurry out of the compression chamber through a mortar pump hose connection and into an attached mortar hose. Accordingly, this method can be used to deliver mortar for building or for injection-molding of pre-cast products like roof tiles. Combined with its novel self-contained stone-making capacity, the ability to process and deliver mortar onsite makes the machine even more versatile and useful as all stone and mortar can be produced onsite using this single apparatus.

In some embodiments of this novel method, a limit switch is employed to control a thickness of the stone product. The use of one or more limit switches thus enables the machine to produce stone products of varying thickness, making the machine even more versatile.

In some embodiments of this novel method, a further step requires an operator to press one or more buttons to close the compression chamber lid. This serves as a safety measure to keep fingers and limbs safely away from the compression chamber when the hydraulically driven lid is closed and locked. As will be appreciated, various warning lights and/or audible alarms may be provided to further warn and alert the operator (and any other person nearby) that the compression chamber lid is being hydraulically closed and locked and that compression/compaction a block is about to occur.

In some embodiments, the method further involves scribing a line down opposite sides of the block to facilitate subsequent shearing of the block using a guillotine. The shearing can be performed using a guillotine attached to the compression station. In another embodiment, the method may involve attaching a PSI testing adaptor in the form of a steel bar in order to perform a compression strength test on a block. The ability to shear blocks and to perform compression tests onsite adds yet further versatility to the mobile factory.

A related aspect of this novel technology is a method of producing stone products with patterned faces on two opposing sides. This method entails inserting a first patterned compression plate into a compression chamber, inserting a second patterned compression plate into the compression chamber, dispensing a batch from a mixer into the compression chamber, compressing the batch in the compression chamber to form a stone product, and separating the first and second patterned compression plates from the stone product after a predetermined period of time has elapsed to reveal patterned faces on the stone product. This method can be performed with or without the mobile factory. This method can thus be performed using stationary stone-press machines to produce dual-faced stone products. As will be appreciated, a single plate may be used in lieu of two plates to produce a stone product having only one patterned face. Where two plates are used, the plates may be either identical or different. As noted above, the patterns may be symbols, logos, letters, numbers, or any other design or image.

Products

This self-contained mobile cement-processing and stone-making factory is extremely versatile and can be used to produce a surprisingly wide variety of stone products. For example, the mobile factory can produce stones, blocks, pavers, tiles, and other types of stone products. For the purposes of this specification, the expression “stone products” is meant to encompass all of these different types of stones, blocks, bricks, pavers, tiles, curbs, edges, veneers or any other stone-like product that is made by compressing aggregate, sand or other local materials with water and optionally cementitious materials, colorant or additives.

Pavers of various shapes and sizes can be manufactured with this machine, e.g. in sizes of 6 inches (15.2 cm), 8 inches (20.3 cm), 10 inches (25.4 cm) and 12 inches (30.5 cm) with thicknesses ranging from 1 inch (2.5 cm) to 3¼ inches (8.3 cm). Colours, shapes and face prints can be varied with smooth and textured surfaces.

Locking retaining walls can also be made in various sizes, e.g. from 3 to 12 inches (7.6 cm to 30.5 cm), and can also be made in variable shapes and colours.

Manufactured stone veneer siding can also be manufactured in various sizes, e.g. from ultra-thin to 6 inches (15.2 cm) thick. These can be sheared to different sizes and produced in different colours.

Solid or hollow building blocks of various sizes can also be made, with or without locks.

The mobile factory (machine) can also manufacture compacted earth blocks (CEB), for example with dimensions of 12×12×6 inches (or 30 cm×30 cm×15 cm).

The mobile factory can also be used to make interior floor tiles. Patio stones can also be made, e.g. up to 24 inches square (60 cm) with variable colours and thickness and also in a multitude of different patterns.

Curbs (e.g. short sectional curbs) can also be manufactured using this mobile factory.

Furthermore, this mobile factory is so versatile that it can even manufacture traditional convex locking roof tiles in a variety of colours. This can be done using special mold inserts that can be loaded into the compression chamber.

In the specific context of the developing world, the mobile factory can be used, with minor adaptations and modifications, for processing liquid fertilizer, for extracting plant and vegetable oil, and for forming charcoal briquettes, to name but a few main applications that would be relevant for the developing world. In addition, the mobile factory can be equipped with other accessories such as, for example, a ventilation fan to cool the operator, block storage racks, a chute for delivering mortar or cement into a wheelbarrow, wireless communications equipment, onboard computer and printer for onsite billing of customers, a canopy or an expandable sunshade, etc. In addition, the mobile factory can be adapted for onboard storage of repair kit, spare parts, spare tire, shovels, spades, rakes, a wheelbarrow or other tools, a first aid kit, a cooler for food and drinks, etc. Various storage compartments, racks, hooks, etc. can be optionally provided in variants of the machine. As will be appreciated, variants of the machine can be adapted to include foldout workbenches, seats, canopies, etc.

By way of summary, the mobile factory is a portable, self-contained stone-making and cement-processing machine that enables novel methods by which stone products of various sizes, colours and shapes can be manufactured quickly, easily and efficiently on a construction site using local aggregate, thus saving the time, cost and effort of transporting finished stone products from a factory to the construction site. This innovative technology is particularly useful and valuable for remote construction sites where the costs of transporting stone products from the closest factory is prohibitively high.

The present invention has been described in terms of specific embodiments, examples, implementations and configurations which are intended to be exemplary or illustrative only. Other variants, modifications, refinements and applications of this innovative technology will become readily apparent to those of ordinary skill in the art who have had the benefit of reading this disclosure. Such variants, modifications, refinements and applications fall within the ambit and scope of the present invention. Accordingly, the scope of the exclusive right sought by the Applicant for the present invention is intended to be limited solely by the appended claims and their legal equivalents.

1. A mobile factory comprising:
a portable frame for supporting the mobile factory and for enabling the mobile factory to be displaced to a construction site;
a receptacle for receiving local aggregate;
a batching module for mixing the local aggregate with cementitious material and water to thereby create a batch;
a compression station for compressing the batch into a stone product; and
a power plant for powering the batching module and the compression station.

2. The mobile factory as claimed in claim 1 further comprising a pair of removable compression plates that can be inserted into a compression chamber of the compression station to produce customized surface finishes on two sides of the stone product when the stone product is compressed in the compression chamber.

3. The mobile factory as claimed in claim 1 wherein the batching module comprises a measuring module for receiving aggregate and a mixer disposed beneath the measuring module, the mixer having mixing paddles equipped with wear bars.

4. The mobile factory as claimed in claim 3 further comprising a mixer-lifting cylinder for lifting the mixer from a batch-mixing position posture to a batch-dispensing posture, the paddles acting to dispense the batch from the mixer when the mixer is in the batch-dispensing posture.

5. The mobile factory as claimed in claim 1 wherein the receptacle comprises a vibrating aggregate screen for screening out aggregate that is excessively large.

6. The mobile factory as claimed in claim 5 wherein receptacle comprises:
a movable hopper top defining an aggregate screening compartment in which the vibrating aggregate screen is disposed; and
a hopper bottom defining an aggregate storage compartment, the hopper bottom being connected to an aggregate dispensing chute for dispensing aggregate into the batching module.

7. The mobile factory as claimed in claim 1 further comprising a tumbler for tumbling stone products produced by the compression station.

8. The mobile factory as claimed in claim 1 further comprising a guillotine for shearing stone products produced by the compression station, the guillotine being connected to a compression cylinder of the compression station.

9. The mobile factory as claimed in claim 1 further comprising a PSI testing adapter, the PSI testing adapter being driven by a compression cylinder of the compression station.

10. The mobile factory as claimed in claim 7 further comprising a PSI testing adapter connected to the guillotine.

11. The mobile factory as claimed in claim 1 further comprising water and add mixture tank connected to an auto moisture injection system.

12. The mobile factory as claimed in claim 1 wherein a compression chamber of the compression station further comprises a mortar pump hose connection through which a mortar slurry can be pumped.

13. The mobile factory as claimed in claim 1 further comprising a block extractor and levelling slide having a pair of handles for extracting each block from a compression chamber after compression.

14. The mobile factory as claimed in claim 1 wherein the portable frame is a trailer having wheels, stabilizers and a trailer hitch coupling.

15. The mobile factory as claimed in claim 1 further comprising an onboard wash-down unit comprising a water tank for storing water and a hose for connecting to the water tank.

16. The mobile factory as claimed in claim 1 wherein the power plant comprises a power takeoff for powering auxiliary equipment.

17. The mobile factory as claimed in claim 1 wherein the power plant is a removable diesel engine power pack that can be removed from the portable frame and placed at a distance from the portable frame in order to reduce noise and vibration for an operator of the mobile factory.

18. The mobile factory as claimed in claim 1 wherein the compression station comprises a compression chamber having pair of opposed threaded holes and a pair of scribing pins threadedly engaged within the respective threaded holes for scribing a groove on opposite sides of the stone product when the stone product is extracted from the compression chamber.

19. The mobile factory as claimed in claim 1 further comprising a replaceable limit switch for controlling a compression cylinder of the compression station to thereby determine a thickness of the stone product to be produced.

20. The mobile factory as claimed in claim 2 wherein a compression chamber of the compression station further comprises a mortar pump hose connection through which a mortar slurry can be pumped.

21. The mobile factory as claimed in claim 20 wherein the batching module comprises a measuring module for receiving aggregate and a mixer disposed beneath the measuring module, the mixer having mixing paddles equipped with wear bars.

22. The mobile factory as claimed in claim 21 further comprising a mixer-lifting cylinder for lifting the mixer from a batch-mixing position posture to a batch-dispensing posture, the paddles acting to dispense the batch from the mixer when the mixer is in the batch-dispensing posture.

23. The mobile factory as claimed in claim 20 wherein the receptacle comprises a vibrating aggregate screen for screening out aggregate that is excessively large.

24. The mobile factory as claimed in claim 23 wherein receptacle comprises:
a movable hopper top defining an aggregate screening compartment in which the vibrating aggregate screen is disposed; and
a hopper bottom defining an aggregate storage compartment, the hopper bottom being connected to an aggregate dispensing chute for dispensing aggregate into the batching module.

25. The mobile factory as claimed in claim 20 further comprising a tumbler for tumbling stone products produced by the compression station.

26. The mobile factory as claimed in claim 20 further comprising a guillotine for shearing stone products produced by the compression station, the guillotine being connected to a compression cylinder of the compression station.

27. The mobile factory as claimed in claim 20 further comprising a PSI testing adapter connected to the guillotine.

28. The mobile factory as claimed in claim 20 further comprising water and add mixture tank connected to an auto moisture injection system.

29. The mobile factory as claimed in claim 20 further comprising a block extractor and levelling slide having a pair of handles for extracting each block from a compression chamber after compression.

30. A method of onsite manufacturing of stone products and onsite processing of cement, the method comprising:
transporting a mobile self-contained stone-making and cement-processing factory to a construction site;
powering the mobile factory using an onboard power plant;
loading local aggregate into a receptacle of the mobile factory;
batching the local aggregate with water and cementitious material;
compressing the batch in a compression chamber to produce a stone product; and
extracting the stone product from the compression chamber.

31. The method as claimed in claim 30 further comprising inserting two removable patterned compression plates into the compression chamber to produce customized surface patterns on two opposite sides of the stone product.

32. The method as claimed in claim 31 further comprising increasing a moisture content in the batch prior to compressing the batch between the patterned compression plates.

33. The method as claimed in claim 31 comprising separating the removable patterned compression plates from the stone product after a predetermined period of time has elapsed ranging from 30 minutes to 12 hours.

34. The method as claimed in claim 30 further comprising screening the local aggregate prior to batching.

35. The method as claimed in claim 34 further comprising:
vibrating an aggregate screen;
storing excess aggregate that has passed through the screen in a hopper bottom aggregate storage; and
pivoting the aggregate screen to dump out large pieces of aggregate that have not passed through the aggregate screen.

36. The method as claimed in claim 30 wherein batching comprises dispensing aggregate into the batching module using a measuring module, injecting a predetermined amount of water from an onboard water tank into the batching module and adding a predetermined amount of cementitious material into the batching module.

37. The method as claimed in claim 30 wherein batching further comprises adding a predetermined quantity of colorant to the batch.

38. The method as claimed in claim 30 further comprising a step of tumbling stone products extracted from the compression chamber in a tumbler.

39. The method as claimed in claim 30 further comprising using a limit switch to control a thickness of the stone product.

40. The method as claimed in claim 30 further comprising scribing grooves in opposite sides of the stone product and shearing the stone product using a guillotine mounted to a compression cylinder.

41. The method as claimed in claim 30 further comprising mounting a PSI testing adaptor to the guillotine and performing a compression test to determine a breaking strength of the stone product.

42. The method as claimed in claim 30 further comprising
mixing a mortar slurry in a mixer;
pouring the mortar slurry into the compression chamber; and
actuating the compression cylinder of the compression chamber to thereby force the mortar slurry out of the compression chamber through a mortar pump hose connection and into an attached mortar hose.

43. The method as claimed in claim 30 further comprising:
loading the batch from a material holding area into the compression chamber;
grading the batch flat using a levelling bar to push material back to the material holding area;
hydraulically closing and locking a compression chamber lid prior to compressing the batch to form the stone product;
unlocking and raising the compression chamber lid;
elevating the stone product to an extraction level; and
pulling on a dual-handle block extractor to extract the stone product from the compression chamber.

44. The method as claimed in claim 43 wherein pulling on the extractor causes a spatula to pull batch material into the compression chamber and causes the compression cylinder to return to a preset position.

45. The method as claimed in claim 30 comprising removing the power plant from the frame to reduce noise and vibration for an operator of the mobile factory.

46. The method as claimed in claim 30 comprising requiring an operator to press one or more buttons to close a compression chamber lid as a safety measure to keep fingers and limbs away from the compression chamber.

47. A method of producing stone products with patterned faces on two opposing sides, the method comprising:
inserting a first patterned compression plate into a compression chamber;
inserting a second patterned compression plate into the compression chamber;
dispensing a batch from a mixer into the compression chamber;
compressing the batch in the compression chamber to form a stone product; and
separating the first and second patterned compression plates from the stone product after a predetermined period of time has elapsed to reveal patterned faces on the stone product.

48. The method as claimed in claim 47 wherein the first patterned compression plate and the second patterned compression plate are identical.

49. The method as claimed in claim 47 wherein the first patterned compression plate and the second patterned compression plate are different.

50. The method as claimed in claim 47 further comprising drying the stone product for a period of time ranging from 30 minutes to 12 hours before separating the plates from the stone product.

51. The method as claimed in claim 47 further comprising increasing a moisture content in the batch prior to compressing the batch between the patterned compression plates.

52. The method as claimed in claim 47 wherein batching comprises dispensing aggregate into the batching module using a measuring module, injecting a predetermined amount of water from an onboard water tank into the batching module and adding a predetermined amount of cementitious material into the batching module.

53. The method as claimed in claim 47 wherein batching further comprises adding a predetermined quantity of colorant to the batch.

54. The method as claimed in claim 47 further comprising a step of tumbling stone products extracted from the compression chamber in a tumbler.

55. The method as claimed in claim 47 further comprising using a limit switch to control a thickness of the stone product.

56. The method as claimed in claim 47 further comprising scribing grooves in opposite sides of the stone product and shearing the stone product using a guillotine mounted to a compression cylinder.

57. The method as claimed in claim 47 further comprising disposing a rubber print on the compression plate.
